(19) United States
(12) Patent Application Publication
(10) Pub. No.: US 2025/0322498 A1
(43) Pub. Date: Oct. 16, 2025

(54) TEXT-GUIDED IMAGE DENOISING AND IMAGE RECONSTRUCTION

(71) Applicant: RAMOT at Tel Aviv University Ltd., Tel Aviv (IL)

(72) Inventors: Raja GIRYES, Tel Aviv (IL); Erez YOSEF, Tel Aviv (IL)

(21) Appl. No.: 19/175,824

(22) Filed: Apr. 10, 2025

Related U.S. Application Data
(60) Provisional application No. 63/632,346, filed on Apr. 10, 2024.

(51) Int. Cl. G06T 5/60; G06T 5/70

(52) U.S. Cl. CPC G06T 5/60; G06T 5/70; G06T 2207/20081; G06T 2207/20084

(57) ABSTRACT

Disclosed herein are novel image denoising and/or image reconstruction techniques. Specifically disclosed herein are methods for text-based image denoising and/or image reconstruction, especially in low-light environments and/or conditions.

### CROSS REFERENCE TO RELATED APPLICATION

This application claims the benefit of U.S. Provisional Application No. 63/632,346, filed Apr. 10, 2024, which is hereby incorporated by reference in its entirety.

### FIELD

The disclosure relates generally to image denoising and image reconstruction and, in particular, novel methods for text-guided image denoising and image reconstruction.

### BACKGROUND

Image acquisition, especially in low-light conditions, can be challenging due to, for instance, low signal and the intrinsic noise of the imaging process. For example, in environments or scenes with low light and/or other limited conditions such as, e.g., a requirement for short exposure intervals (due to, for instance, a dynamic scene), the signal-to-noise ratio (SNR) is poor. Image denoising and reconstruction are fundamental problems in the context of imaging.

Though many different approaches have been proposed over the years, including, for instance, parametric and nonparametric algorithms and deep learning approaches, all known available approaches have various weaknesses. For example, one approach is to try to learn or obtain a good “prior” of natural images along with modeling the true statistics of the noise in any given scene. However, in low-light conditions, such approaches are usually insufficient and additional information is required (e.g., in the form of multiple captures), which increases error, cost, and/or difficulty of image denoising and/or image reconstruction.

Given the foregoing, there exists a significant need for improved image denoising and/or image reconstruction, especially in low-light conditions or in other challenging and/or sub-optimal lighting and/or environmental conditions.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In certain embodiments, the disclosed embodiments may include one or more of the features described herein.

In general, the present disclosure is directed towards image denoising and/or image reconstruction. In at least one embodiment, novel methods are disclosed for text-based image denoising and/or image reconstruction that can be used in, for instance, low-light conditions.

In at least one embodiment, a text-conditioned neural network (e.g., a diffusion model) is disclosed for image denoising and reconstruction. In at least one example, the diffusion model is text-conditioned with the addition of text captions for the raw images.

In at least one embodiment, a diffusion model is trained on a dataset that contains both images and captions for those images. The images may be passed to a model to convert them to sensor raw images. In at least one example, the sensor raw images and simulated noise are added to the diffusion model for training. In at least another example, the captions are processed by an encoder, resulting in embedding vectors (that is, representations of the text captions) that are then used to train the diffusion model.

In at least one embodiment, the trained diffusion model is fine-tuned using real-world noise. In at least one example, samples are captured (e.g., twice with different camera settings to either increase noise or reduce/eliminate noise, respectively). In at least one example, log λₛₕₒₜ=0.1 and log λ_{read}=0.2 for the increased noise samples, and log λₛₕₒₜ=0.3 and log λ_{read}=0.5 for the reduced noise samples, λₛₕₒₜ and λ_{read} being shot (photon) and read (readout circuitry) components of noise variance, respectively. The samples and the embedding vectors are then input into the trained diffusion model to fine-tune the model. In at least one example, the fine-tuning is performed by a low-rank adaptation (LORA), which is known and described in, e.g., Hu et al., “LoRA: Low-Rank Adaptation of Large Language Models,” arXiv:2106.09685 (2021). In particular, and as is known generally, a low-rank weight matrix may be added to the original pre-trained weights, and only this small set of parameters is fine-tuned while the original network stays fixed.

In at least one embodiment, noise modeling is performed by approximating overall noise as a heteroscedastic Gaussian distribution with variance depending on the true image z. The parameters λ_{read} and λₛₕₒₜ of the noise variance are determined according to the sensor's analog and digital gains. In at least one example, using real-world sensor noise level statistics, the noise level parameters λ_{read} and λₛₕₒₜ of the read and shot components are then sampled from a distribution, as described further below herein.

In at least one embodiment, the diffusion model is trained by conditioning the model on a timestep value t using, e.g., positional encoding followed by two fully connected (FC) layers that are separated by an activation function. In addition, in at least one embodiment, the network is conditioned on text input using two similar FC layers applied to the text embedding vectors (e.g., CLIP text embedding vectors). The two vectors obtained are then summed and added to the features of each convolution block along the network.

Therefore, based on the foregoing and continuing description, the subject invention in its various embodiments may comprise one or more of the following features in any non-mutually-exclusive combination:
A system comprising a memory storing computer-readable instructions, and at least one processor to execute the computer-readable instructions to: input one or more raw images into a text-conditioned neural network trained on a dataset comprising both (i) a plurality of dataset images, and (ii) a plurality of dataset captions for the plurality of dataset images; input one or more text captions describing the one or more raw images into the text-conditioned neural network; and run the text-conditioned neural network on the one or more raw images and the one or more text captions, to generate one or more denoised and reconstructed images;
The at least one processor further to execute computer-readable instructions to: fine-tune the trained text-conditioned neural network using real-world noise;
The fine-tuning the trained text-conditioned neural network using real-world noise further comprising capturing, by an imaging device, a plurality of samples;
The fine-tuning the trained text-conditioned neural network using real-world noise further comprising inputting the plurality of samples into the trained text-conditioned neural network;
The fine-tuning the trained text-conditioned neural network further comprising processing, by an encoder, text descriptions of the plurality of captured samples to generate embedding vectors;
The fine-tuning the trained text-conditioned neural network further comprising inputting the embedding vectors into the trained text-conditioned neural network;
The fine-tuning the trained text-conditioned neural network further comprising optimizing a low-rank set of parameters on the plurality of samples and the embedding vectors to fine-tune the trained text-conditioned neural network;
The plurality of samples comprising a first dataset and a second dataset;
The first dataset having a higher amount of noise than the second dataset;
The fine-tuning the trained text-conditioned neural network being performed using low-rank adaptation (LORA);
The at least one processor executing the computer-readable instructions to further: query, by a graphical user interface (GUI), a user to enter at least one text description of the one or more raw images;
The one or more text captions comprising the at least one text description;
The at least one processor further to execute computer-readable instructions to: train the text-conditioned neural network on the dataset comprising both (i) the plurality of dataset images, and (ii) the plurality of dataset captions for the plurality of dataset images, to generate the trained text-conditioned neural network;
The training the text-conditioned neural network further comprising passing, by the at least one processor, the plurality of dataset images to a model to convert the plurality of dataset images to a plurality of sensor raw images;
The training the text-conditioned neural network further comprising processing, by an encoder on the at least one processor, the plurality of dataset captions, to generate embedding vectors;
The training the text-conditioned neural network further comprising adding, by the at least one processor, simulated noise to the plurality of sensor raw images to create noisy images;
The training the text-conditioned neural network further comprising training the text-conditioned neural network on the noisy images and the embedding vectors, using the sensor raw images as ground truth;
The text-conditioned neural network being fine-tuned on a dataset that includes pairs of raw noisy images of actual objects with text captions, each pair comprising a high-noise image and a low-noise image;
The text-conditioned neural network being a diffusion model;
A method comprising inputting, by at least one processor, one or more raw images into a text-conditioned neural network trained on a dataset comprising both (i) a plurality of dataset images, and (ii) a plurality of dataset captions for the plurality of dataset images; inputting, by the at least one processor, one or more text captions describing the one or more raw images into the text-conditioned neural network; and running, by the at least one processor, the text-conditioned neural network on the one or more raw images and the one or more text captions, to generate one or more denoised and reconstructed images;
The method further comprising fine-tuning, by the at least one processor, the trained text-conditioned neural network using real-world noise;
The fine-tuning the trained text-conditioned neural network with real-world noise comprising capturing, by an imaging device, a plurality of pairs of sample images;
In each pair of sample images, both sample images are of the same scene and one image is captured with different imaging device settings than the other image in the pair, so that the one image is noisy and the other image is clean;
The fine-tuning the trained text-conditioned neural network with real-world noise comprising inputting, by the at least one processor, the noisy sample images into the trained text-conditioned neural network;
The fine-tuning the trained text-conditioned neural network with real-world noise comprising inputting, by the at least one processor, embedding vectors for the noisy sample images into the trained text-conditioned neural network;
The fine-tuning the trained text-conditioned neural network with real-world noise comprising utilizing, by the at least one processor, a low-rank adaptation (LORA) on the plurality of noisy sample images and the embedding vectors to fine-tune the trained text-conditioned neural network, using the clean images as ground truth;
The method further comprising training, by the at least one processor, the text-conditioned neural network on the dataset comprising both (i) the plurality of dataset images, and (ii) the plurality of dataset captions for the plurality of dataset images, to generate the trained text-conditioned neural network;
The training the text-conditioned neural network further comprising passing the plurality of dataset images to a model to convert the plurality of dataset images to a plurality of sensor raw images;
The training the text-conditioned neural network further comprising processing, by an encoder, the plurality of dataset captions to generate embedding vectors;
The training the text-conditioned neural network further comprising adding, by the at least one processor, simulated noise to the plurality of sensor raw images to create noisy images;
The simulated noise being generated by calculating, based on an imaging device's analog and digital gains, parameters of noise variance; and sampling the parameters from a distribution using real-world sensor noise statistics;
The training the text-conditioned neural network further comprising training the text-conditioned neural network on the noisy images and the embedding vectors, using the sensor raw images as ground truth;
The training the text-conditioned neural network further comprising conditioning the text-conditioned neural network on a timestep value t by utilizing positional encoding followed by a first fully connected layer and a second fully connected layer, the first fully connected layer and the second fully connected layer separated by an activation function;
The training the text-conditioned neural network further comprising conditioning the text-conditioned neural network to text input by utilizing a third fully connected layer and a fourth fully connected layer applied to text embedding vectors;
A non-transitory computer-readable storage medium comprising instructions stored thereon that, when executed by a computing device cause the computing device to perform operations, the operations comprising inputting one or more raw images into a text-conditioned neural network trained on a dataset comprising both (i) a plurality of dataset images, and (ii) a plurality of dataset captions for the plurality of dataset images; inputting one or more text captions describing the one or more raw images into the text-conditioned neural network; and running the text-conditioned neural network on the one or more raw images and the one or more text captions, to generate one or more denoised and reconstructed images;
The operations further comprising capturing, by an imaging device, a plurality of samples;
The operations further comprising inputting the plurality of samples into the trained text-conditioned neural network;
The operations further comprising inputting embedding vectors associated with the plurality of samples into the trained text-conditioned neural network;
The operations further comprising utilizing a low-rank adaptation (LORA) on the plurality of samples and the embedding vectors to fine-tune the trained text-conditioned neural network;
The operations further comprising training the text-conditioned neural network on the dataset comprising both (i) the plurality of dataset images, and (ii) the plurality of dataset captions for the plurality of dataset images, to generate the trained text-conditioned neural network;
The training the text-conditioned neural network further comprising passing the plurality of dataset images to a model to convert the plurality of dataset images to a plurality of sensor raw images;
The training the text-conditioned neural network further comprising processing, by an encoder, the plurality of dataset captions, to generate embedding vectors;
The training the text-conditioned neural network further comprising adding simulated noise to the plurality of sensor raw images to create noisy images;
The training the text-conditioned neural network further comprising training the text-conditioned neural network on the noisy images and the embedding vectors, using the sensor raw images as ground truth; and
The text-conditioned neural network comprising a diffusion model.

These and further and other objects and features of the invention are apparent in the disclosure, which includes the above and ongoing written specification, as well as the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 shows images that demonstrate the effect of denoising and reconstruction, according to at least one embodiment.

FIGS. 2A-2C show overviews of diffusion training on simulated data (FIG. 2A), fine-tuning the trained diffusion model on real-world noise (FIG. 2B), and training and text conditioning of a diffusion model (FIG. 2C), each according to at least one embodiment.

FIG. 3 shows images demonstrating raw image denoising for various models at a lower noise level, according to at least one embodiment.

FIG. 4 shows images demonstrating raw image denoising for various models at a higher noise level, according to at least one embodiment.

FIG. 5 shows additional images that demonstrate the effect of denoising and reconstruction, according to at least one embodiment.

FIG. 6 shows further images of outdoor scenes and real-world captures that demonstrate the effect of denoising and reconstruction, according to at least one embodiment.

FIGS. 7A-7D show a method for image denoising and reconstruction, according to at least one embodiment.

FIG. 8 is a block diagram of a computing system for image denoising and reconstruction, according to at least one embodiment.

FIG. 9 is a block diagram of a computing device, according to at least one embodiment.

FIG. 10 shows an example of a system for implementing certain aspects of the present technology.

FIG. 11 shows a further example of a system for implementing certain aspects of the present technology.

FIG. 12 is a diagram illustrating the benefits of a novel dataset that includes both raw noisy images and text captions of actual objects.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, “at least one of A, B, and C” indicates A or B or C or any combination thereof. As used herein, the singular forms “a”, “an,” and “the” are intended to include the plural forms as well, unless the context clearly indicates otherwise.

It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, ranges are used herein in shorthand, so as to avoid having to list and describe each and every value within the range. Any appropriate value within the range can be selected, where appropriate, as the upper value, lower value, or the terminus of the range.

“About” means a referenced numeric indication plus or minus 10% of that referenced numeric indication. For example, the term “about 4” would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims, each numerical parameter should be construed in light of the number of significant digits and ordinary rounding approaches.

The words “comprise,” “comprises,” and “comprising” are to be interpreted inclusively rather than exclusively. Likewise, the terms “include,” “including,” and “or” should all be construed to be inclusive, unless such a construction is clearly prohibited from the context. The terms “comprising” or “including” are intended to include embodiments encompassed by the terms “consisting essentially of” and “consisting of.” Similarly, the term “consisting essentially of” is intended to include embodiments encompassed by the term “consisting of.” Although having distinct meanings, the terms “comprising,” “having,” “containing,” and “consisting of” may be replaced with one another throughout the description of the invention.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Wherever the phrase “for example,” “such as,” “including” and the like are used herein, the phrase “and without limitation” is understood to follow unless explicitly stated otherwise.

“Typically” or “optionally” means that the subsequently described event or circumstance may or may not occur, and that the description includes instances where said event or circumstance occurs and instances where it does not.

In general, the word “instructions,” as used herein, refers to logic embodied in hardware or firmware, or to a collection of software units, possibly having entry and exit points, written in a programming language, such as, but not limited to, Python, R, Rust, Go, SWIFT, Objective-C, Java, JavaScript, Lua, C, C++, or C#. A software unit may be compiled and linked into an executable program, installed in a dynamic link library, or may be written in an interpreted programming language such as, but not limited to, Python, R, Ruby, JavaScript, or Perl. It will be appreciated that software units may be callable from other units or from themselves, and/or may be invoked in response to detected events or interrupts. Software units configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. Generally, the instructions described herein refer to logical modules that may be combined with other modules or divided into sub-modules despite their physical organization or storage. As used herein, the term “computer” is used in accordance with the full breadth of the term as understood by persons of ordinary skill in the art and includes, without limitation, desktop computers, laptop computers, tablets, servers, mainframe computers, smartphones, handheld computing devices, and the like.

In this disclosure, references are made to users performing certain steps or carrying out certain actions with their client computing devices/platforms. In general, such users and their computing devices are conceptually interchangeable. Therefore, it is to be understood that where an action is shown or described as being performed by a user, in various implementations and/or circumstances the action may be performed entirely by the user's computing device or by the user, using their computing device to a greater or lesser extent (e.g. a user may type out a response or input an action, or may choose from preselected responses or actions generated by the computing device). Similarly, where an action is shown or described as being carried out by a computing device, the action may be performed autonomously by that computing device or with more or less user input, in various circumstances and implementations.

In this disclosure, various implementations of a computer system architecture are possible, including, for instance, thin client (computing device for display and data entry) with fat server (cloud for app software, processing, and database), fat client (app software, processing, and display) with thin server (database), edge-fog-cloud computing, and other possible architectural implementations known in the art.

Generally, the present disclosure is directed towards image denoising and/or image reconstruction. In particular, the disclosure relates to methods for text-based image denoising and/or image reconstruction, especially in low-light environments and/or conditions.

As stated above herein, current approaches to image denoising and/or image reconstruction suffer from various weaknesses in challenging environments, including, but not limited to, low-light conditions. One such weakness is a low signal-to-noise ratio (SNR). Since the true statistics of the noise in any given environment and/or scene are unknown and specific to the given camera or imaging device used, various methods have been used to better approximate noise characteristics, including, for instance, using Gaussian noise, a Poisson-Gaussian noise model, etc. However, such methods are ill-suited for severe noise conditions and the basic “prior” of natural images is neither specific enough nor informative enough for image reconstruction.

Classical methods for image denoising, such as thresholding and total variation, use hand-crafted parametric algorithms to attempt to recover a denoised image. Such methods heavily rely on assumptions about the image data and noise statistics.

Current single-image denoising algorithms can use deep neural networks and/or deep learning methods, including, for instance, training Multi-Layer Perceptron (MLP) on large synthetic noise images. However, since there are statistical differences between simulated noise and real sensor noise, having a real (i.e., camera-captured) dataset is required for improved model performance. Further, capturing such a dataset of clean and noisy image pairs is difficult since the alignment of the camera/image device must be carefully maintained, and both the camera and the scene must remain static during image capture. Finally, though self-supervised methods exist, these methods use only noisy samples without any ground truth.

In at least one embodiment of the invention, a novel method for image denoising and/or image reconstruction is disclosed which generally comprises adding a description of the environment or scene as a prior. Such description can be done via, for instance, the user (e.g., photographer) who is capturing the scene. The method can further comprise utilizing a text-conditioned neural network (e.g., a text-conditioned diffusion model) to add image caption information, which significantly improves image reconstruction in, e.g., low-light conditions for both synthetic and actual “real-world” images.

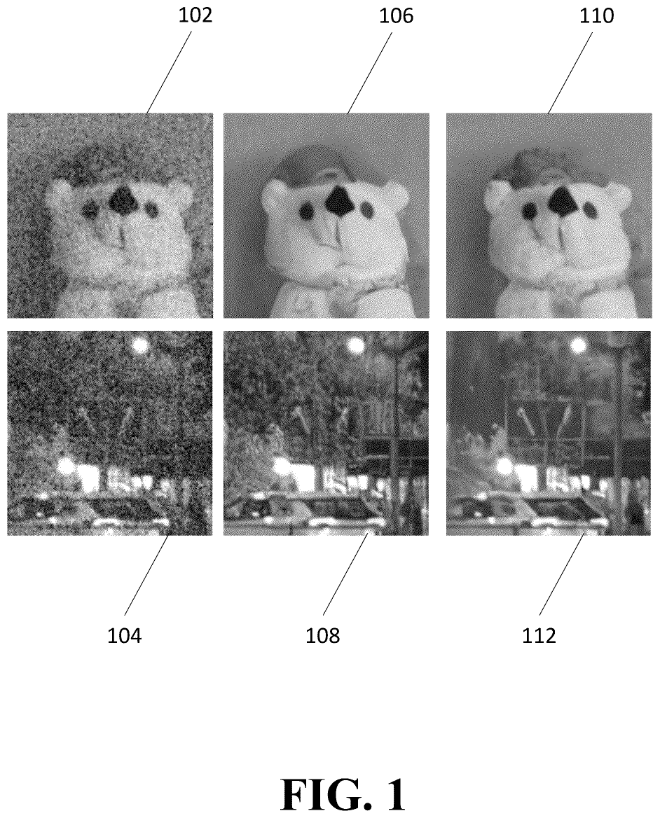

Image sets that demonstrate at least one embodiment of the invention are shown in FIG. 1. Specifically, two different images 102 and 104 were captured using a camera (e.g., a smartphone camera). Both such images were denoised and reconstructed using (1) a conventional model, producing images 106 and 108, and (2) a text-conditioned diffusion model according to at least one embodiment of the invention, producing images 110 and 112. For the text-conditioned diffusion model, a text caption was added, specifically “a fluffy furry hedgehog doll in brown colors” to image 102 and “a green road sign with two white arrows on the street” to image 104. As can be seen, the images 110 and 112 produced by the text-conditioned diffusion model are of higher perceptual quality than either (1) the raw images 102 and 104, or (2) the conventionally reconstructed images 106 and 108.

In at least one example, the additional textual information and/or caption for an image may be provided by a user or the photographer of the scene, and then integrated into the image reconstruction process. The process includes, in at least one embodiment, a diffusion model conditioned by input data for the image denoising and/or image reconstruction task. In at least one example, a Contrastive Language-Image Pre-training (CLIP) multimodal method is used to integrate the text caption and the raw image into a single framework for reconstruction. Additionally, in at least one embodiment, a method is disclosed herein for camera-specific and real-world noise fine-tuning of the diffusion model to improve performance. For instance, a low-rank set of weights of the model can be optimized using a small set of image captures from the imaging device or camera.

Diffusion models, and more specifically denoising diffusion probabilistic models (“DPPM” or “DPPMs”), are generative models that can be used for image generation, image segmentation, and image reconstruction. For low-level image restoration, diffusion models can be used for image restoration of linear inverse problems, spatially-variant noise removal, and the like.

Generally, DPPM is a type of generative model that performs a parameterized Markov chain to produce samples of a certain data distribution after a specific number of steps. In the forward direction, the Markov chain gradually adds noise to the image data until the data is mapped to a simple distribution (e.g., isotropic Gaussian). When sampling an image, and starting with pure noise from the known distribution, the image is gradually denoised, namely in the reverse direction of the Markov chain. The reverse steps can be performed using a trained deep network.

Input data is denoted as x₀˜q(x₀) from a data distribution q, and the latent steps of the process are x₁, x₂, . . . , x_{T} (for T timesteps) such that x_{T} is pure Gaussian noise. The forward process is presented in Equation (1) below by adding a small amount of noise to the sample at each timestep t given the previous step sample, where β₁, . . . , β_{T} is a fixed variance schedule of the process. The noise scheduling is designed such that x_{T}˜N(0, I).

$$q ( {x}_{t} \vert {x}_{t - 1} ) := N ( {x}_{t} ; \sqrt{1 - {β}_{t}} {x}_{t - 1} , {β}_{t} I ) \qquad ( 1 )$$

An important property of the forward process is that sampling xₜ at any timestamp t given x₀ can be expressed in closed form by Equation (2) below, where αₜ:=1−βₜ and α̅ₜ:=Πₛ₋₁^{t}αₛ.

$$q ( {x}_{t} \vert {x}_{0} ) := N ( {x}_{t} ; \sqrt{{\overline{α}}_{t}} {x}_{0} , ( 1 - {\overline{α}}_{t} ) I ) \qquad ( 2 )$$

Accordingly, xₜ can be expressed as a linear combination of x₀ and a noise ε˜N (0, I), as shown in Equation (3) below.

$${x}_{t} = \sqrt{{\overline{α}}_{t}} {x}_{0} + \sqrt{1 - {\overline{α}}_{t}} ϵ \qquad ( 3 )$$

The process is reversed by iteratively recovering a signal from a noise. The previous timestamp sample xₜ₋₁ is achieved using a parametrized model (e.g., a trained neural network). The sample at t−1 can be described as a Gaussian with a learned mean and a fixed variance, as shown below in Equation (4).

$${p}_{ϑ} ( {x}_{t - 1} \vert {x}_{t} ) = N ( {x}_{t - 1} ; {μ}_{ϑ} ( {x}_{t} , t ) , {σ}_{t}^{2} I ) \qquad ( 4 )$$

The diffusion model can, in at least one embodiment, be conditioned by additional data y such that the conditional distribution of the data is x₀˜q(x₀|y), and the reverse step model takes the conditional information as an additional input μ_{ϑ}(xₜ, y, t) to obtain a conditional prediction and generate a sample conditioned by the data.

Generative models can learn a representative distribution that maximizes perceptual quality, rather than a deterministic solution that reduces the L2-norm (the square root of the sum of the squares of entries of the vector (that is, the difference between the result and the target)) and induces high peak signal-to-noise ratio (PSNR). This difference can be termed “perception-distortion tradeoff.” Thus, generative models can perform worse on traditional distortion metrics such as PSNR and Structural Similarity Index Measure (SSIM). Indeed, PSNR as a metric does not necessarily capture perceptual quality; higher PSNR values do not necessarily correspond to higher perceptual quality.

At least one embodiment of the disclosure was evaluated using various different perceptual evaluation metrics, including, for instance, PSNR, Learned Perceptual Image Patch Similarity (LPIPS), and Deep Image Structure and Texture Similarity (DISTS).

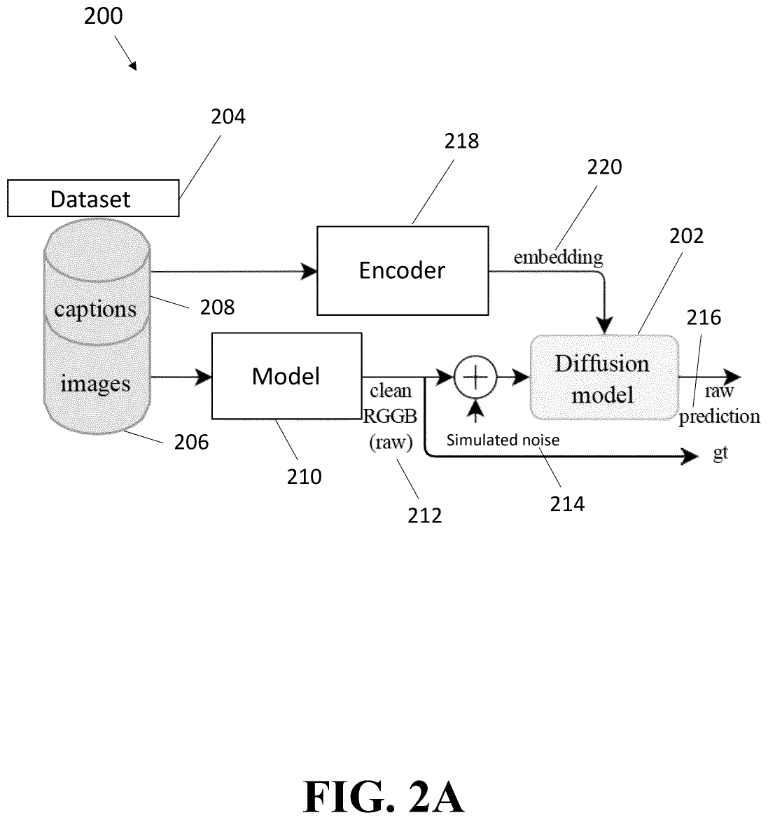

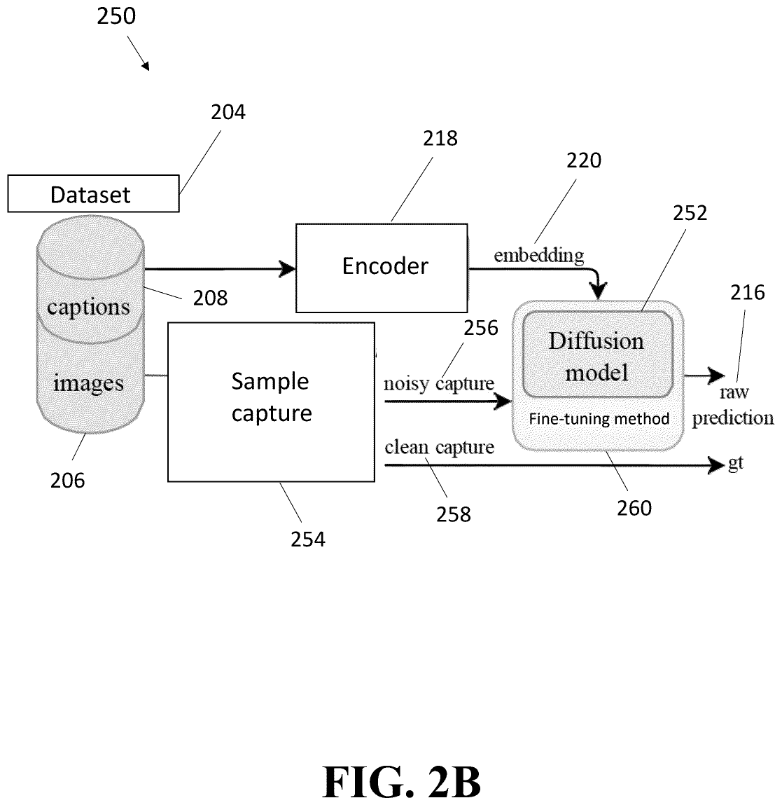

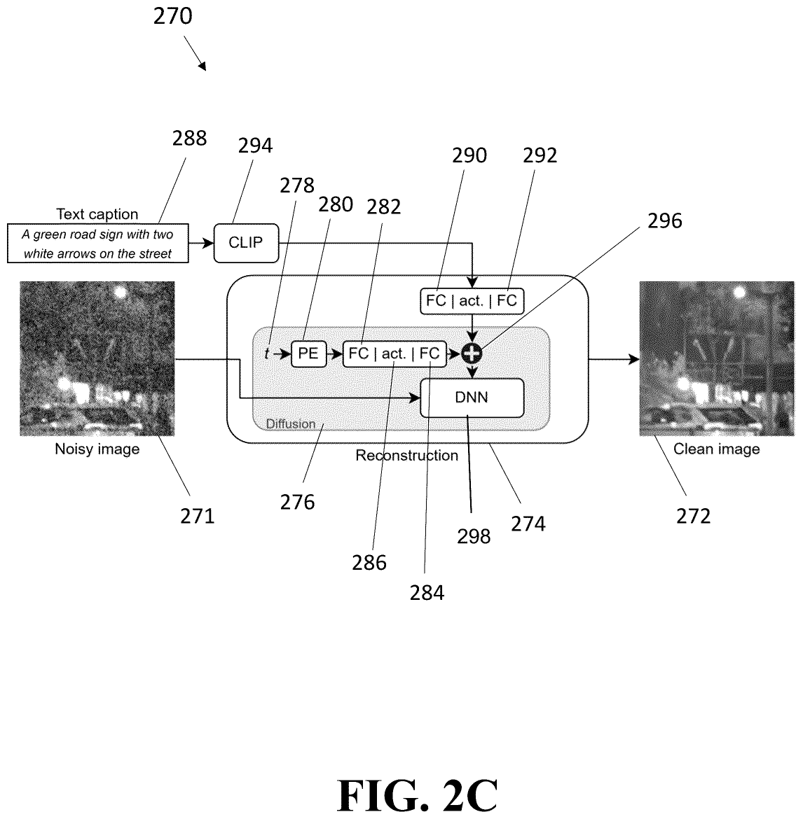

FIG. 2A shows an overview 200 of diffusion training on simulated data, according to at least one embodiment of the invention. Further details regarding the diffusion training will be presented below herein. Generally, a diffusion model 202 was trained on a dataset 204 that contains both images 206 and captions 208 for those images. The diffusion model 202 then outputs raw prediction 216. In at least one example, the dataset 204 is the COCO-captions dataset, which contains about 120,000 red-green-blue (RGB) images (that is, images where each pixel is defined by the amount of red, green, and blue colors) with text captions. To obtain raw sensor data of the images 206 in the dataset 204, the images are passed to model 210 (e.g., the RGB2RAW network branch of the CycleISP model) to convert them to sensor raw images 212 in, e.g., Bayer pattern format. Simulated noise 214 was then added, and both the raw images 212 and the simulated noise 214 were used to train the diffusion model 202, which outputs raw prediction 216 from raw images with simulated noise 214, which may be compared to the raw images 212 without simulated noise, which can be taken as the ground truth.

The captions 208 were processed in a known manner by encoder 218 (e.g., the ViT-L/14 text encoder of CLIP), resulting in embedding vectors 220 of length 768. Such vectors are representations of the text captions, which are then used to train the diffusion model 202. In at least one example, encoder 218 comprises an image encoder and a text encoder. Both encoders can map input data to a vector in a shared domain. The encoders can be trained such that the dot product between the representation vectors of the image and the text is minimized, which results in an improved differentiation over representations that have a high dot-product score. Additional details regarding the training are set forth below herein. Accordingly, representations of a matching image and text will result in a high dot-product score, while representations of a non-matching image and text will result in a low dot-product score. This allows for the joining of both a text domain and an image domain. In at least one example, text captions are utilized only for image editing and one or more high-level tasks such as, for instance, colorization, super-resolution, and the like.

In FIG. 2A, both the model 210 and the encoder 218 are fixed, and the diffusion model 202 is trained in each stage.

Turning now to FIG. 2B, an overview 250 is shown for fine-tuning the trained diffusion model 252 using real-world noise. This can be achieved by, for instance, capturing samples 254. In at least one example, the captured samples are presented on a computer screen using an imaging device (e.g., a smartphone camera). The samples can be captured twice with different camera settings to either increase noise (producing noisy capture samples 256) or reduce/eliminate noise (producing clean capture samples 258), respectively. Fine-tuning method 260 uses both the noisy capture samples 256 and the embedding vectors 220 to fine-tune the trained diffusion model 252. The raw prediction 216 output by the diffusion model 252 based on the noisy capture 256 may be compared to the clean capture 258 which may be taken as the ground truth.

In at least one example, the fine-tuning method 260 is low-rank adaptation (LORA), which is a method for fine-tuning a large deep model trained for a general task to a specific sub-task. Specifically, a low-rank weight matrix can be added to the original pre-trained weights of the network operations, and only this small set of parameters is fine-tuned while the original network stays fixed. Additional details regarding the fine-tuning are set forth below herein.

In FIG. 2B, both the trained model 252 and the encoder 218 are fixed, and the fine-tuning method 260 is trained in each stage.

Thus, in at least one embodiment, the fine-tuned diffusion model denoises raw images captured by a camera sensor to enable text-based reconstruction of a clean image of a captured scene from a raw, noisy image. For instance, given a raw, noisy image and a text description of the captured scene, a clean raw image is generated using the trained diffusion model. This model was trained, for example, on simulated data, as shown in FIG. 2A.

### Noise Modeling

Generally, the digital imaging process suffers from intrinsic noise that affects the measurements of the image sensor. A low SNR is caused by the low intensity of the signal, namely, the light collected by the sensor photodiodes.

Formally, the captured raw sensor image y can be represented as random variables with a distribution conditioned by a true image z of the scene: p_{cam}(y|z).

The camera noise is mainly due to photon arrival statistics and readout circuitry noise. The photon (shot) noise can be Poisson distributed with a mean of the true light intensity. The readout noise distribution can be approximated by Gaussian noise with a zero mean and fixed variance. However, data for the supervised training of deep learning models for raw image denoising tasks is hard to achieve with known solutions since pairs of clean and noisy images are required. Further, a perfect match (pixel-by-pixel) between image pairs is required to capture the image pair sequentially with different settings to control the noise levels.

In addition, although the noise can be minimized using various imaging setups, noise cannot be totally eliminated since it is an intrinsic part of the imaging process. Further, acquiring a “true” clean image is impractical.

In at least one embodiment, a large dataset with noisy and clean images is obtained by simulating camera noise using a noise model for raw image denoising. Considering the two main noise components described above, the overall noise can be approximated as a heteroscedastic Gaussian distribution with variance depending on the true image z, as shown in Equation (5) below. The parameters λ_{read} and λₛₕₒₜ of the noise variance are determined according to the sensor's analog and digital gains.

$$y ∼ {p}_{com} ( y \vert z ) \approx N ( y ; μ = z , {σ}^{2} = {λ}_{read} + {λ}_{shot} z ) \qquad ( 5 )$$

Using real-world sensor noise level statistics, the noise level parameters λ_{read} and λₛₕₒₜ of the read and shot components are then sampled from the distribution shown in Equation (6) below. The range of the noise parameters can be determined according to noise statistics of real-world cameras, and the range can be extended to be more robust and less dataset-specific.

$$log ( {λ}_{shot} ) ∼ U ( a = log ( 0.1 ) , b = log ( 0.31 ) ) log ( {λ}_{read} ) \vert log ( {λ}_{shot} ) ∼ N ( μ = 1.5 \cdot log ( {λ}_{shot} ) + 0. 05 , {σ}^{2} = 0.5 ) \qquad ( 6 )$$

Using the sampling methodology above, simulated samples can be generated for the training process of the diffusion model.

### Diffusion Model and Training

In at least one embodiment, the diffusion model is trained by setting T=1,000 diffusion steps with a cosine noise scheduler. To condition the diffusion process by a noisy image, the raw noisy image y is concatenated to the diffusion sample xₜ for each step. An architecture with 8 input channels for xₜ and y images was rearranged to a 4-channel RGGB format in a well-known manner. The output of the network is therefore the conditional estimation of the sample mean in the 4 channels of the RGGB raw image. In at least one example, all samples had the same spatial dimension of 256×256.

FIG. 2C shows this training and text conditioning in the context of the process 270 of converting a noisy image 271 to a clean image 272. As described herein, image reconstruction 274 utilizes, in at least one embodiment, a diffusion process 276 and deep neural network 298, which may be similar to, or the same as, any neural network described herein (e.g., a diffusion model). The aforementioned architecture is controlled by the timestep value t 278 using, e.g., positional encoding (PE) 280 followed by two fully connected (FC) layers 282, 284 that are separated by an activation function 286. In addition, in at least one embodiment, the network is conditioned on text input (here, text caption 288 of “a green road sign with two white arrows on the street”) using two similar FC layers 290, 292 applied to the text embedding vectors (e.g., CLIP text embedding vectors 294). The two vectors obtained are then summed 296 and added to the features of each convolution block along the network 298.

In at least one embodiment, the aforementioned approach to text conditioning is also used for a text-based image generation model. Specifically, the model is trained to estimate the denoised sample x₀ using L1 loss (that is, L1 norm being used as a loss function). For comparison, a diffusion model without text conditioning may also be trained, using a single trainable vector instead of image-specific embedding vectors.

### Real Camera Noise Fine-Tuning

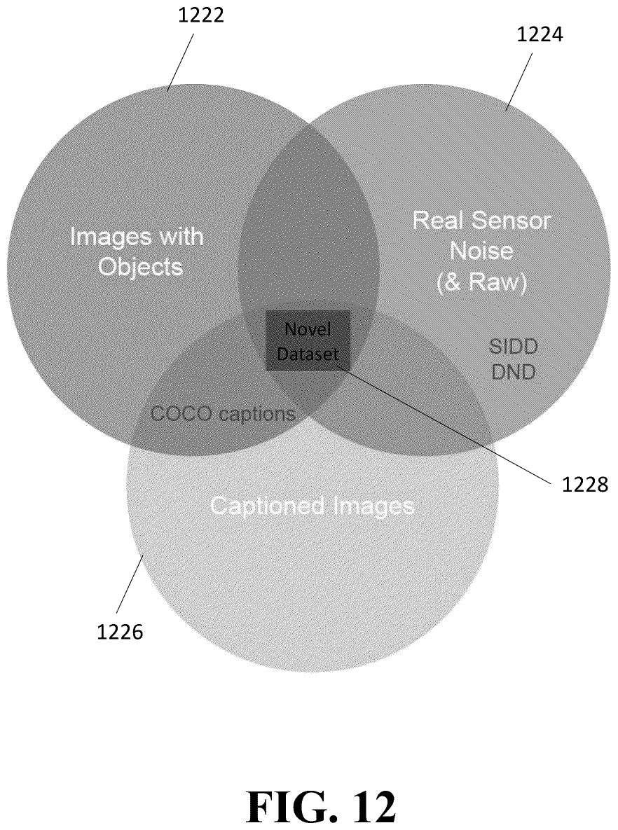

Real sensor noise can be different from the simulated noise used for training described above. Additionally, sensor noise can be camera-specific. Accordingly, in at least one embodiment of the invention, the model is fine-tuned to achieve improved performance. To bridge the gap between a simulated training dataset and real-world noise statistics, which can cause performance degradation, the at least one embodiment uses captured datasets of noisy and clean image pairs. The trained diffusion model is then fine-tuned on real, noisy sensor measurements. In at least one embodiment, a novel dataset is generated that contains the aforementioned noisy and clean image pairs. FIG. 12 is a Venn diagram showing (1) images with objects 1222, (2) real sensor noise and raw images 1224, and (3) captioned images 1226. There is a lack of existing sources of raw noisy images with text captions of actual objects (rather than simply abstract concepts). For instance, existing raw noisy image datasets such as, e.g., Smartphone Image Denoising Dataset (SIDD) and Darmstadt Noise Dataset (DND), lack captions and, moreover, include images that cannot be captioned. By contrast, captioned datasets, such as, e.g., COCO, contain RGB images with captions but do not include raw noisy sensor images. Accordingly, at least one embodiment of the invention comprises a novel dataset 1228 that includes both raw noisy images and text captions of actual objects. To capture both noisy and clean images/image pairs, various imaging devices and/or cameras (e.g., both smartphone cameras and non-smartphone cameras) can be used.

In at least one example, both a smartphone camera (e.g., from a Samsung-branded smartphone) and a conventional stand-alone (that is, non-smartphone) camera (e.g., an Allied Vision-branded camera) are used, and the images are recorded in raw format (Bayer pattern) with both 10-bit depth and 12-bit depth, respectively. Each imaging device may be placed about 110 centimeters (cm) from a light emitting diode (LED) screen presenting samples of a text captions dataset (e.g., the COCO-captions dataset) such that the text captions are still relevant to the captured images (that is, there is no need to caption new images). About 500 images may be captured for training and about 30 images may be used for testing. Each image is sampled twice: First, settings for high noise levels are used (e.g., an exposure of about 1/12,000 seconds and an ISO value of 3,200), and second, settings that reduce the noise as much as possible are used (e.g., an exposure of about 1/50 seconds and an ISO value of about 50). This sampling generates pairs of noisy and clean images, respectively. The images are then saved in raw format (e.g., Bayer pattern), as described above herein.

In at least one example, a fine-tuning method such as LORA is used to optimize a low-rank set of parameters on the dataset. Specifically, low-rank weights are added to the fully connected of the attentions and the convolutions of the residual-block layers. For these fully connected layers, a ΔW matrix from a low rank of r is added to the pre-trained matrix weight W₀∈R^{d×k}. Therefore, the low-rank matrix can be represented as ΔW=AB, while A∈R^{d×r} and B∈R^{r×k} are trainable matrices. The operation may be performed as shown in Equation (8) below for input data x and output y.

$$y = {W}_{0} x + Δ Wx = {W}_{0} x + ABx \qquad ( 8 )$$

For two-dimensional (2D) convolutions, the low rank may be performed along the channels dimension; namely, the input data is mapped by a convolution layer to r channels (a low dimension) before it is re-mapped to the number of the output channels and summed with the pre-trained weight result. In at least one example, r=4.

While in some embodiments, a model is completely pre-trained and fine-tuned before interacting with a user, in other embodiments there are multiple models which may be selected from by a user, and/or a user may additionally fine-tune such a model themselves. For example, since noise varies between devices, a user in some embodiments may select a model fine-tuned on real-world data specific to the type (e.g. smart phone/standalone) and/or model of imaging device that was used to collect the image the user wishes to denoise/reconstruct. Such model may, for instance, have already been trained and/or fined-tuned for a specific type/model of imaging device and/or a specific type of data. Similarly, a user may generate their own low/high-noise image pairs using the user's own device and fine-tune a model using that data in order to attempt to achieve higher accuracy.

### Evaluation of Results

In at least one embodiment, various results using the aforementioned methods, trained models, and/or fine-tuned models were obtained. As described above herein, evaluation can be performed via PSNR on the raw format images, and additional structural and perceptual metrics (e.g., SSIM, LPIPS, DISTS, etc.) can be performed on the RGB form of the images.

To convert the raw images to RGB format, a known, deterministic process may be used that includes applying gains (e.g., for brightness and white balance), de-mosaicking using, for instance, 3×3 convolutions, color correction matrices, and conversions from linear to gamma space.

In at least one example, two diffusion models were trained and tested, the first with the text caption of given scene and the second without the text caption. Since the addition of the text caption is a key difference between these two models, the significance of the contribution of the text caption to reconstruction in high-noise conditions can be assessed. As shown below herein, the diffusion model that was trained on text captions outperforms known models, including, for instance, known models for raw image denoising (e.g., CycleISP, which was designed for low noise levels and achieved poor results on noisy real-world data, deep image prior (DIP), and Noise2Void) and known models for RGB image denoising (e.g., Restormer, TECDNet, and NAFnet). To enable a fairer evaluation of various metrics (e.g., PSNR), the aforementioned known models were also fine-tuned using the real world training dataset described above herein.

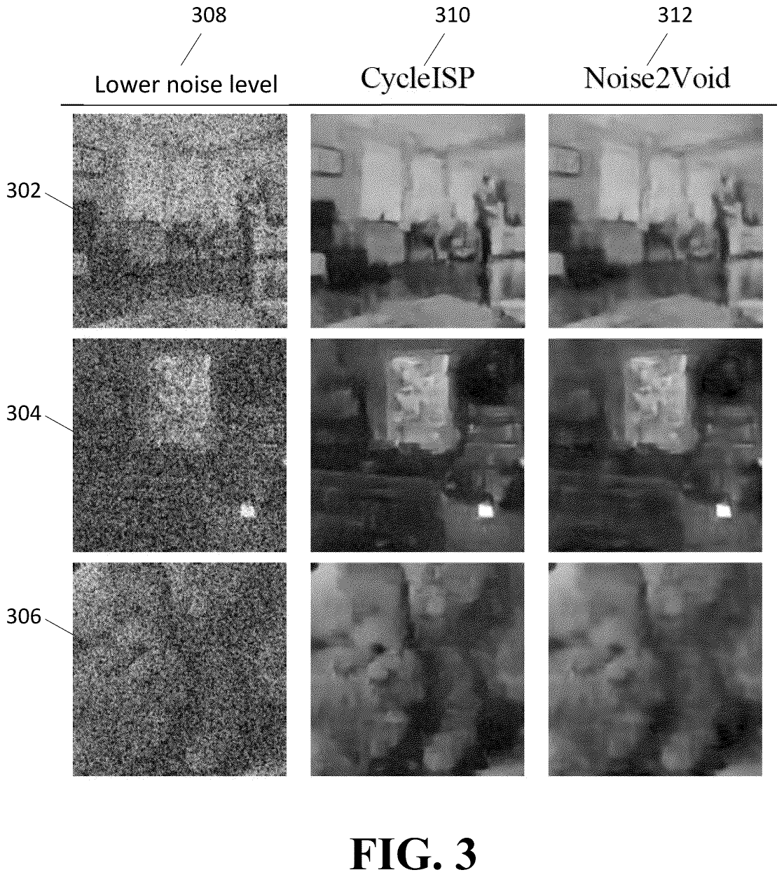

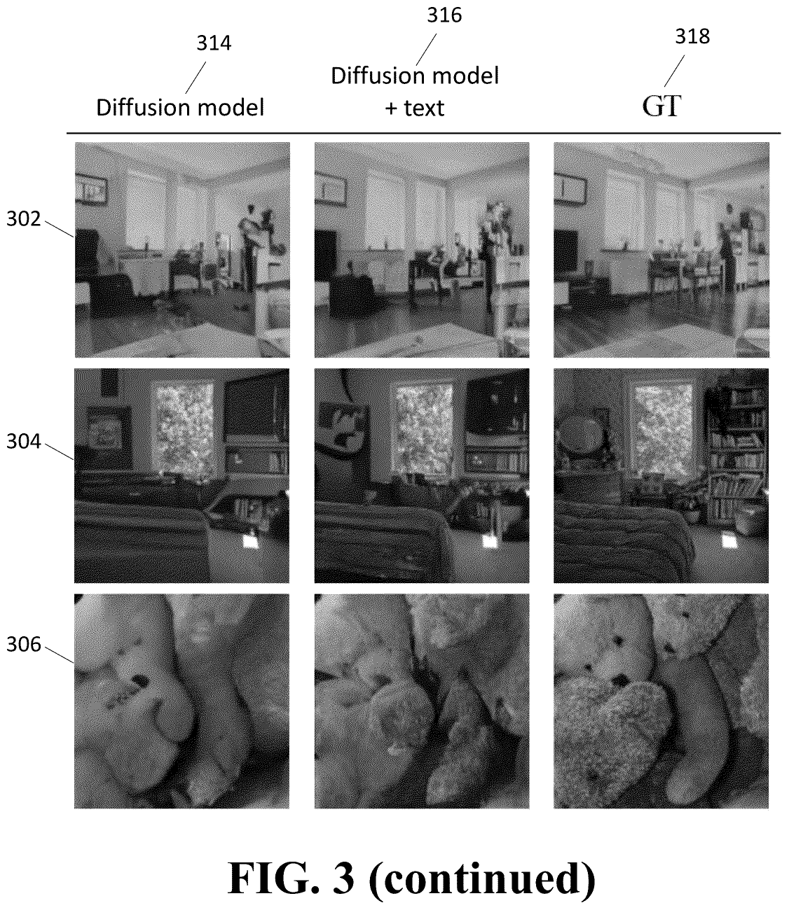

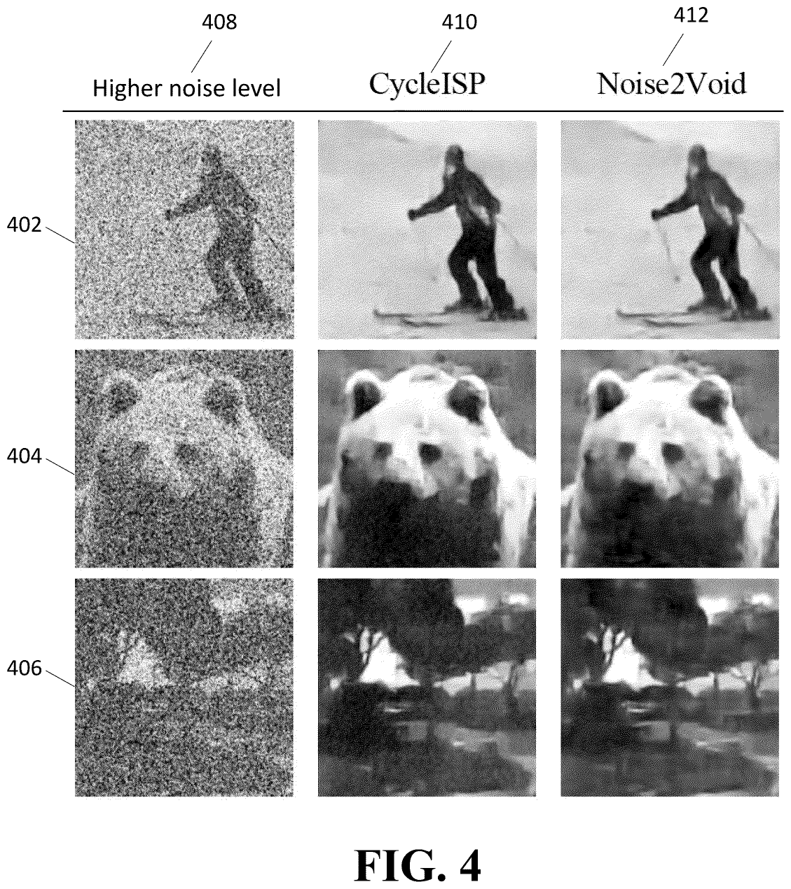

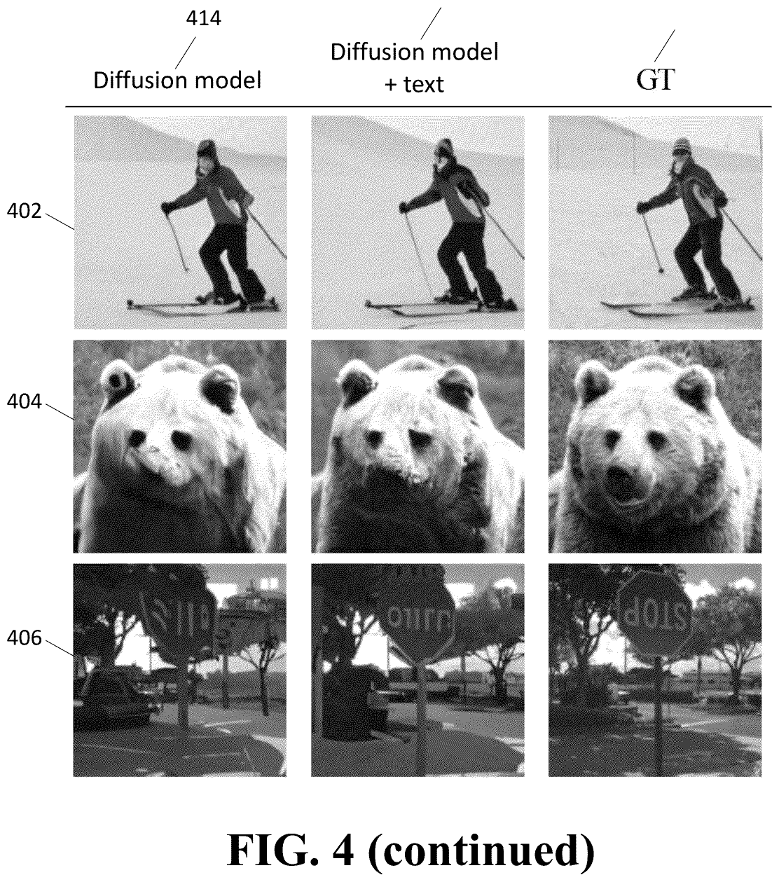

Two levels of simulated noise were used. The lower noise level represents noise sampled according to the noise model described above herein (e.g., with specific reference to Equation (6)), where log λₛₕₒₜ=0.1 and log λ_{read}=0.2. The higher noise level represents noise sampled according to the noise model described above herein (e.g., with specific reference to Equation (6)), where log λₛₕₒₜ=0.3 and log λ_{read}=0.5. The synthetic noise was sampled with a fixed seed, and all competing methods were trained on the same data and noise simulation. The visual/image results for the lower noise level are presented in FIG. 3, with accompanying quantitative evaluations presented in Table 1. The visual/image results for the higher noise level are presented in FIG. 4, with accompanying quantitative evaluations presented in Table 2.

Specifically, FIG. 3 shows three different images 302, 304, and 306 for raw image denoising at the lower noise level 308 (that is, where log λₛₕₒₜ=0.1 and log λ_{read}=0.2) and for various models (the known CycleISP model 310, the known Noise2Void model 312, the diffusion model 314 according to at least one embodiment of the invention, the diffusion model with text caption conditioning 316 according to at least one embodiment of the invention, and the known ground truth (GT) images 318). In at least one example, the text captions were as follows: “a room with tables, chairs, and a woman in it” for image 302, “a bedroom scene with a bookcase, blue comforter, and window” for image 304, and “three teddy bears, each a different color, snuggling together” for image 306. As can be seen, the diffusion model 314 and the diffusion model with text caption conditioning 316 achieved superior results, with text conditioning contributing to improved perceptual quality, details, and/or textures.

Table 1 below shows a quantitative comparison of results on the aforementioned lower noise level. As can be seen, both the diffusion model (that is, model 314) and the diffusion model with text conditioning (that is, model 316) achieved (1) better (higher) SSIM, (2) better (lower) LPIPS, and (3) better (lower) DISTS, compared to the other known models tested.

TABLE 1
Quantitative comparison of results on a lower noise level
where log λₛₕₒₜ = 0.1 and log λ_{read} = 0.2

| | PSNR | PSNR | | | |
|---|---|---|---|---|---|
| | (raw | (RGB | | | |
| Method | images) | images) | SSIM | LPIPS | DISTS |
| CycleISP | 26.84 | 21.59 | 0.589 | 0.394 | 0.270 |
| DIP | 22.00 | 13.83 | 0.413 | 0.632 | 0.448 |
| Noise2Void | 26.52 | 20.45 | 0.614 | 0.418 | 0.285 |
| Diffusion | 27.93 | 24.10 | 0.640 | 0.255 | 0.190 |
| model | | | | | |
| Diffusion | 29.72 | 24.00 | 0.629 | 0.250 | 0.182 |
| model with text | | | | | |
| conditioning | | | | | |

FIG. 4 shows three different images 402, 404, and 406 for raw image denoising at the higher noise level 408 (that is, where log λₛₕₒₜ=0.3 and log λ_{read}=0.5) and for various models (the known CycleISP model 410, the known Noise2Void model 412, the diffusion model 414 according to at least one embodiment of the invention, the diffusion model with text caption conditioning 416 according to at least one embodiment of the invention, and the known GT images 418). Again, similar to FIG. 3, the diffusion model 414 and the diffusion model with text caption conditioning 416 achieved superior results, with text conditioning contributing to improved perceptual quality, details, and/or textures.

Table 2 below shows a quantitative comparison of results on the aforementioned higher noise level. As can be seen, both the diffusion model (that is, model 414) and the diffusion model with text conditioning (that is, model 416) achieved (1) better (higher) or comparable SSIM, (2) better (lower) LPIPS, and (3) better (lower) DISTS, compared to the other known models tested.

TABLE 2
Quantitative comparison of results on a lower noise
level where log λₛₕₒₜ = 0.3 and log λ_{read} = 0.5

| | PSNR | PSNR | | | |
|---|---|---|---|---|---|
| | (raw | (RGB | | | |
| Method | images) | images) | SSIM | LPIPS | DISTS |
| CycleISP | 24.25 | 19.18 | 0.440 | 0.537 | 0.322 |
| Noise2Void | 25.14 | 20.02 | 0.567 | 0.479 | 0.309 |
| Diffusion | 25.23 | 21.73 | 0.515 | 0.411 | 0.243 |
| model | | | | | |
| Diffusion | 25.24 | 21.78 | 0.516 | 0.397 | 0.228 |
| model with text | | | | | |
| conditioning | | | | | |

In Tables 1 and 2, although both the diffusion model and the diffusion model with text conditioning had comparable (or better) PSNR values, a higher PSNR value itself does not necessarily reflect “better” image quality, as described above herein. Indeed, the models according to embodiments of the invention maximize perceptual quality rather than focusing on reducing the mean square error.

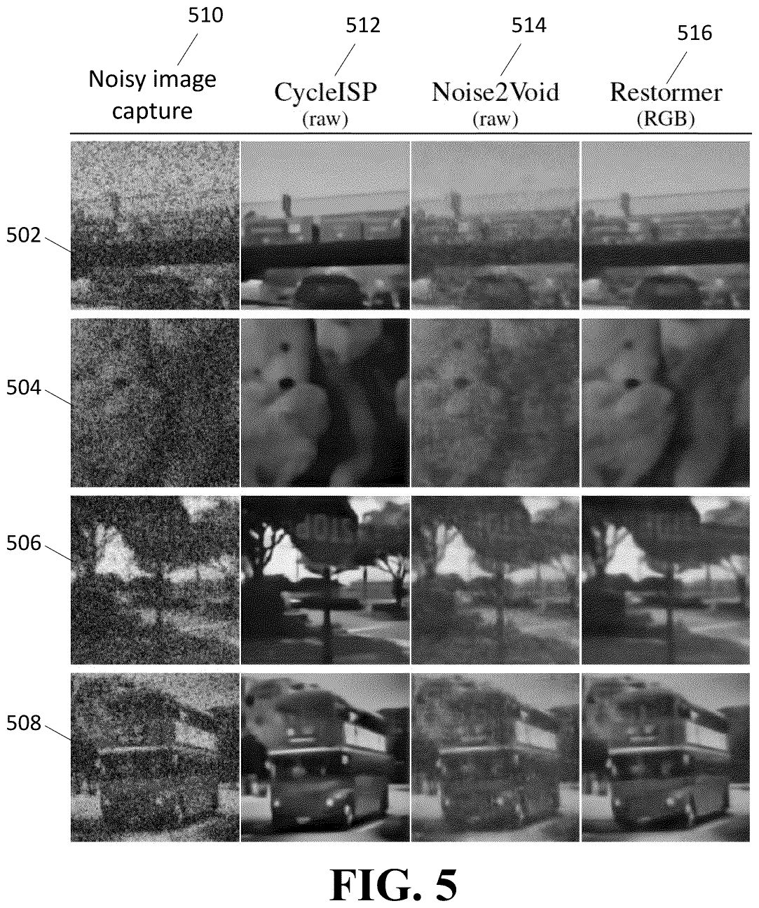

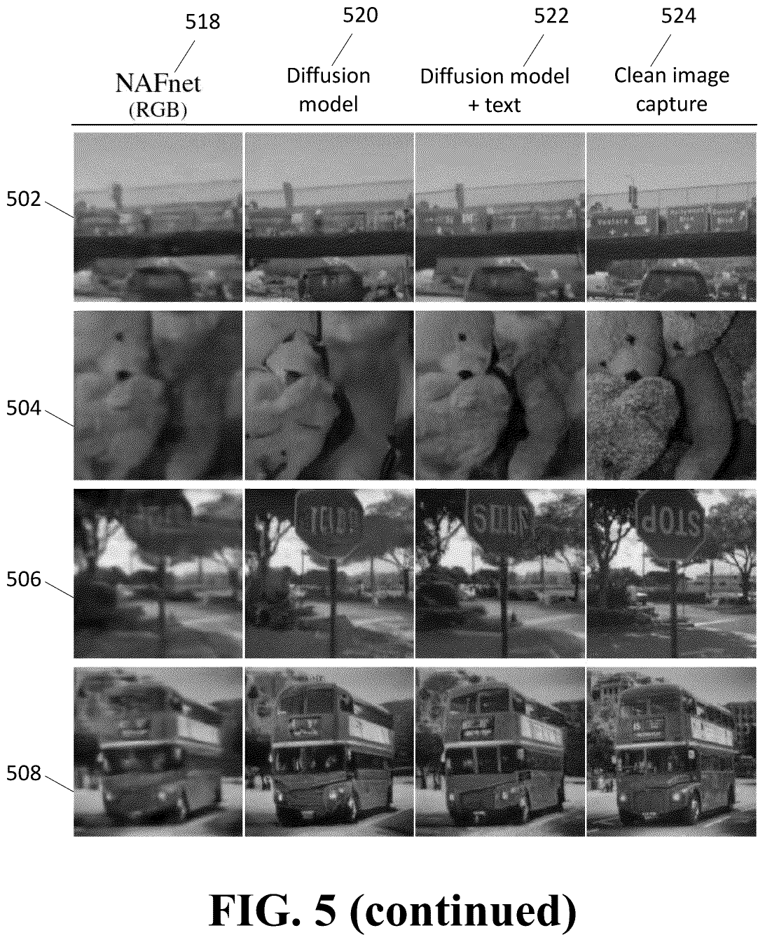

Testing at least one embodiment of the invention on real sensor test images with noise statistics (as captured in a laboratory setting and described above with respect to the fine-tuning of the diffusion model) achieved superior results compared to other methods in perceptual quality. As a non-limiting example, image samples from a dataset (e.g., the COCO dataset) were presented on the screen of a computing device and captured twice (e.g., with both a smartphone camera and a non-smartphone camera) with different settings to have noisy and clean/GT image pairs. Specifically, FIG. 5 shows the results for the smartphone camera, while Table 4 below herein shows the results for the non-smartphone camera. In FIG. 5, image samples 502, 504, 506, and 508 for various models (the known CycleISP model 512 for raw images, the known Noise2Void model 514 for raw images, the known Restormer model 516 for RGB images, the known NAFnet model 518 for RGB images, the diffusion model 520 for raw images, according to at least one embodiment of the invention, and the diffusion model with text caption conditioning 522 according to at least one embodiment of the invention) are shown. The noisy captures 510 and the clean/GT captures 524 are also shown. As can be seen, the diffusion model 520 and the diffusion model with text caption conditioning 522 achieved superior results, with text conditioning contributing to improved perceptual quality, details, and/or textures.

Table 3 below shows a quantitative comparison of the images shown in FIG. 5. In particular, two different versions of CycleISP were used, specifically (1) the original version (with original weights as presented in the original journal article), and (2) a trained version. As can be seen, both the diffusion model (that is, model 520) and the diffusion model with text conditioning (that is, model 522) achieved (1) better (higher) or comparable SSIM, (2) better (lower) LPIPS, and (3) better (lower) DISTS, compared to the other known models tested. Additionally, fine-tuning both model 520 and model 522 improved the results even further. These results show that the novel models and methods described herein achieve better performance than known models in PSNR (for both raw and RGB images) and perceptual metrics such as SSIM, LPIPS, and/or DISTS.

Also shown in Table 3 is the CLIP score (“CS”), which specifically measures how well the text caption corresponds to an image via, e.g., taking the cosine similarity between the embeddings of the text caption and the image. The comparable or better (higher) CS values of models 520 and 522 compared to known models indicate superior performance.

TABLE 3
Quantitative comparison of results for real sensor noise
using captures of image samples from a smartphone camera

| | PSNR | PSNR | | | | |
|---|---|---|---|---|---|---|
| Method | (raw images) | (RGB images) | SSIM | LPIPS | DISTS | CS |
| CycleISP | 20.95 | 14.59 | 0.111 | 0.862 | 0.506 | 20.50 |
| (original) | | | | | | |
| CycleISP | 24.50 | 21.75 | 0.618 | 0.445 | 0.288 | 22.69 |
| (trained) | | | | | | |
| DIP | 23.60 | 18.41 | 0.460 | 0.629 | 0.360 | 19.81 |
| Noise2Void | 24.25 | 20.52 | 0.574 | 0.488 | 0.306 | 21.38 |
| Restormer | N/A | 21.94 | 0.635 | 0.427 | 0.288 | 21.94 |
| NAFnet | N/A | 21.97 | 0.627 | 0.423 | 0.276 | 22.42 |
| TECDNet | N/A | 22.07 | 0.636 | 0.427 | 0.289 | 22.51 |
| Diffusion | 24.60 | 22.07 | 0.583 | 0.322 | 0.219 | 21.93 |
| model | | | | | | |
| Diffusion | 24.57 | 21.95 | 0.589 | 0.300 | 0.204 | 23.34 |
| model with | | | | | | |
| text | | | | | | |
| conditioning | | | | | | |

Table 4 below shows the quantitative comparison of results for real sensor noise using results for the non-smartphone camera. As is the case with FIG. 5 and Table 3, the novel models and methods described herein achieve better performance than known models in PSNR (for both raw and RGB images) and perceptual metrics such as SSIM, LPIPS, and/or DISTS. The novel models also had comparable (or better) CLIP scores than various known models.

TABLE 4
Quantitative comparison of results for real sensor noise using
captures of image samples from a non-smartphone camera

| | PSNR | PSNR | | | | |
|---|---|---|---|---|---|---|
| Method | (raw images) | (RGB images) | SSIM | LPIPS | DISTS | CS |
| CycleISP | 30.71 | 20.44 | 0.764 | 0.317 | 0.234 | 24.63 |
| (original) | | | | | | |
| CycleISP | 32.47 | 24.53 | 0.761 | 0.245 | 0.195 | 25.89 |
| (trained) | | | | | | |
| Restormer | N/A | 25.30 | 0.797 | 0.184 | 0.171 | 25.04 |
| NAFnet | N/A | 26.22 | 0.799 | 0.186 | 0.173 | 25.55 |
| TECDNet | N/A | 25.18 | 0.795 | 0.227 | 0.192 | 25.91 |
| Diffusion | 33.61 | 26.53 | 0.808 | 0.163 | 0.145 | 25.38 |
| model | | | | | | |
| Diffusion | 33.48 | 26.26 | 0.806 | 0.163 | 0.144 | 25.85 |
| model with | | | | | | |
| text | | | | | | |
| conditioning | | | | | | |

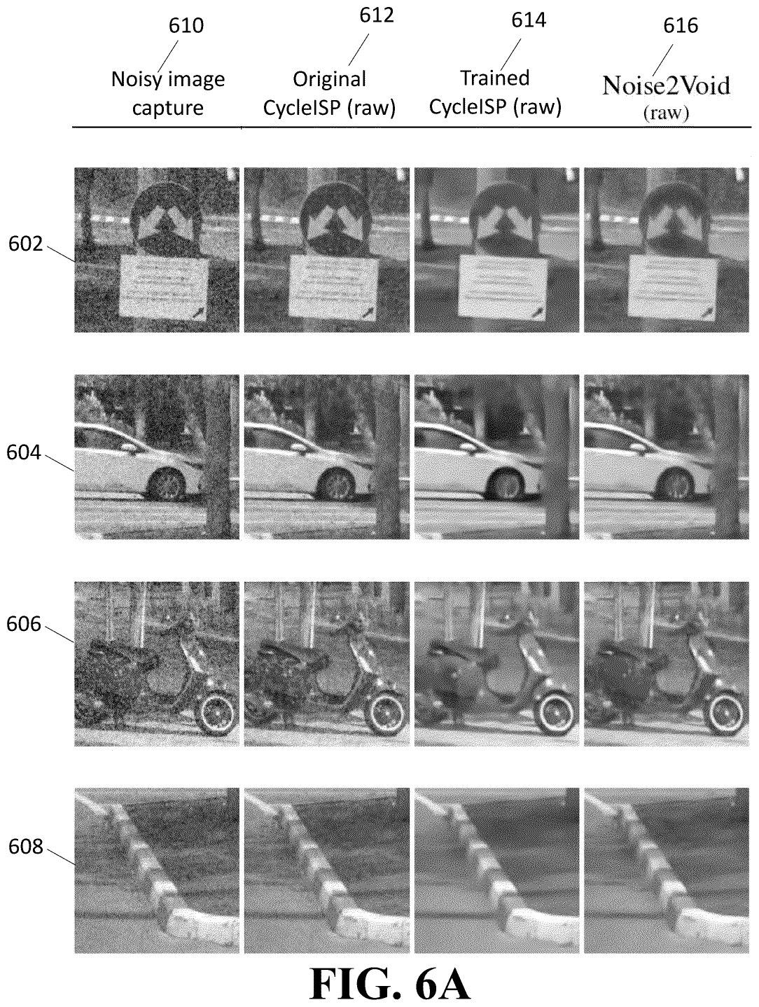

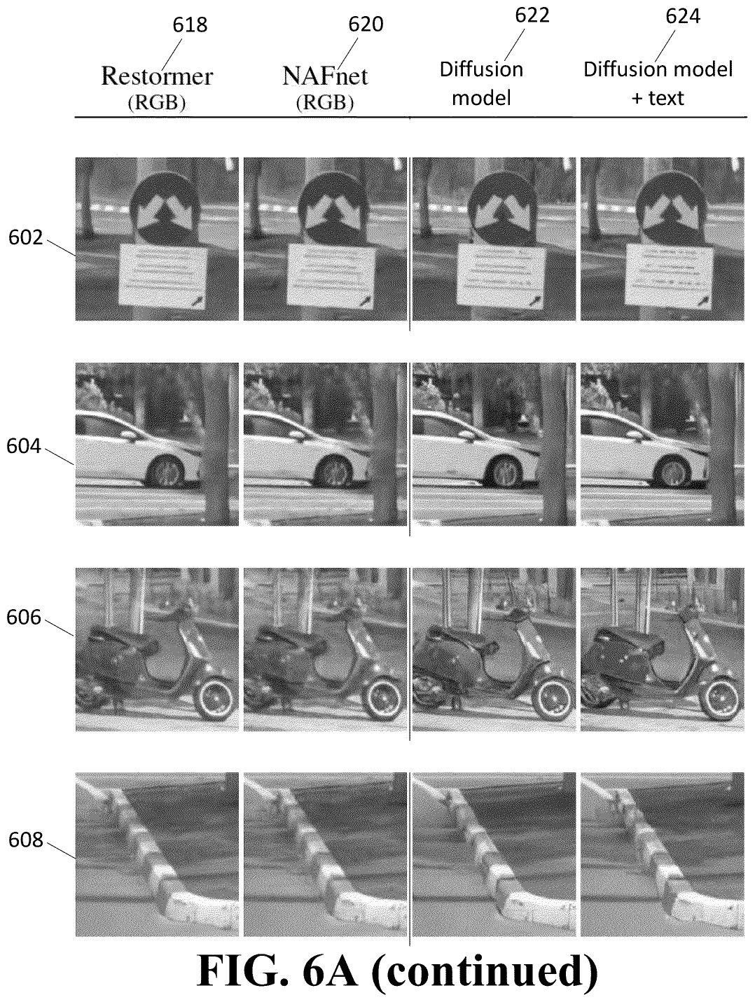

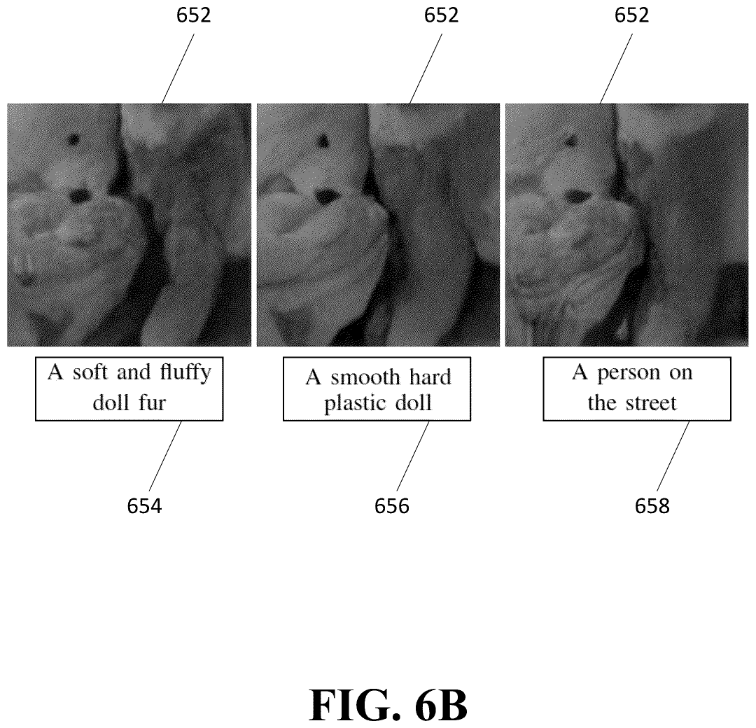

FIG. 6 presents additional results for various outdoor scenes and real-world image captures (that is, captures without corresponding reference images). Specifically, images 602, 604, 606, and 608 are shown for various models (the known CycleISP model 612 with original weights, the known CycleISP model 614 with trained weights, the known Noise2Void model 616, the known Restormer model 618, the known NAFnet model 620, the diffusion model 622 according to at least one embodiment of the invention, and the diffusion model with text caption conditioning 624 according to at least one embodiment of the invention). The original noisy image capture 610 is also shown. In at least one example, the text captions were as follows: “a blue road sign with two white arrows and a white sign with text” for image 602, “a car on a street with a tree” for image 604, “a red scooter on the street” for image 606, and “a red and white curbstone with grass and road” for image 608. As can be seen, the diffusion model 622 and the diffusion model with text caption conditioning 624 achieved superior results, with text conditioning contributing to improved perceptual quality, details, and/or textures.

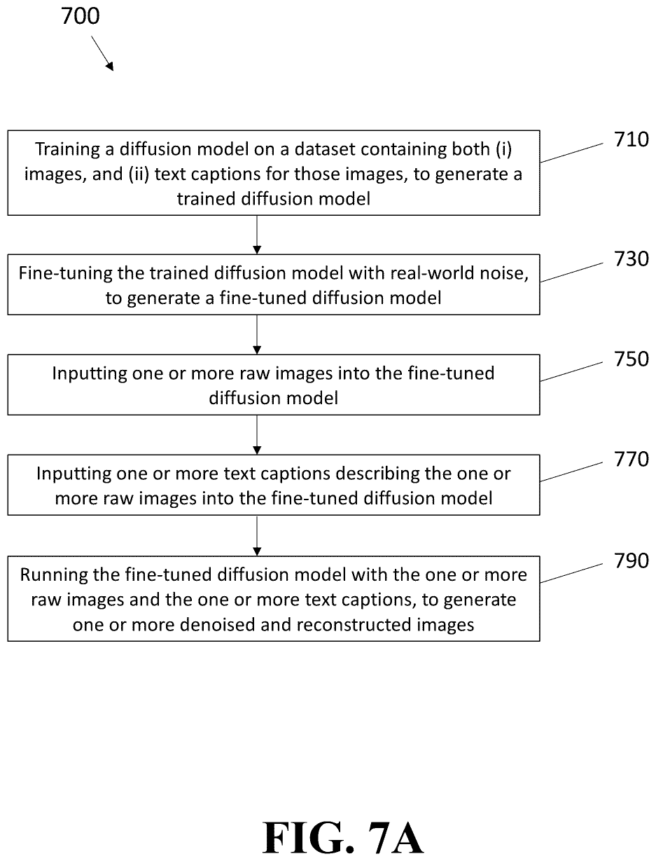

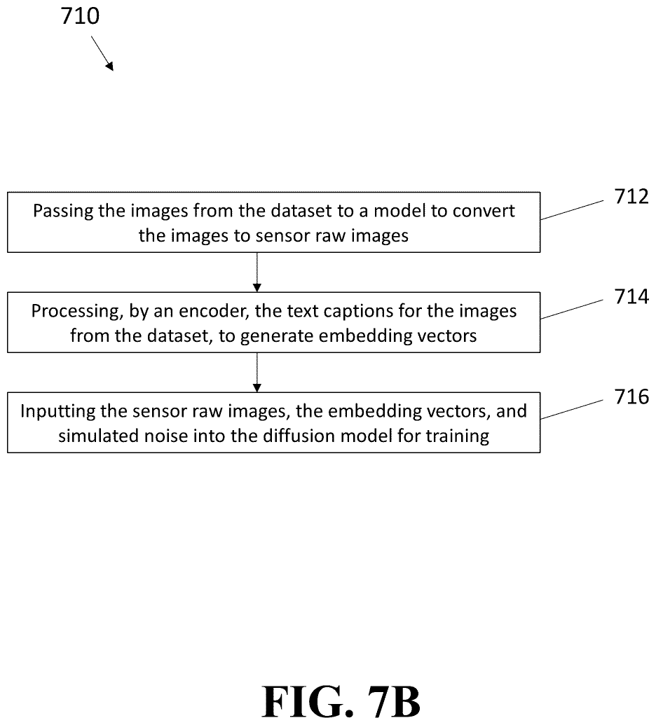

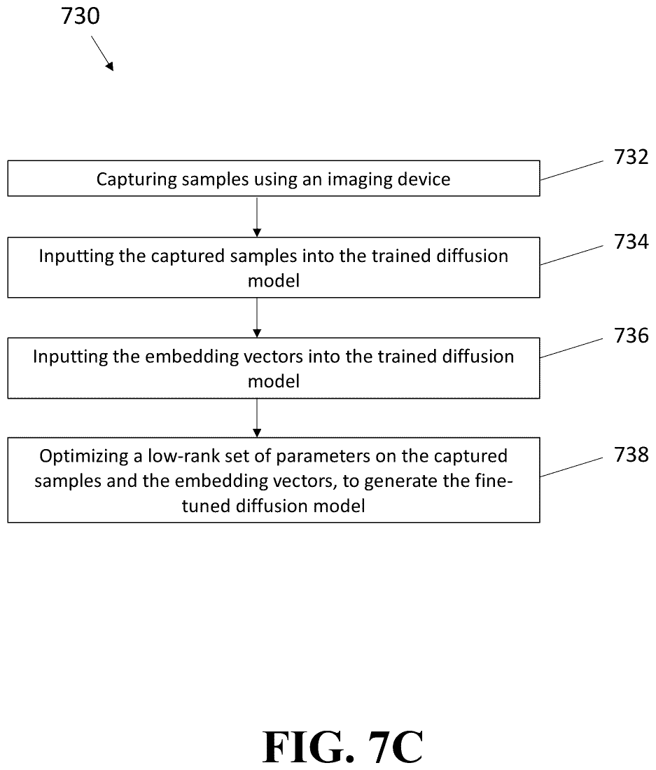

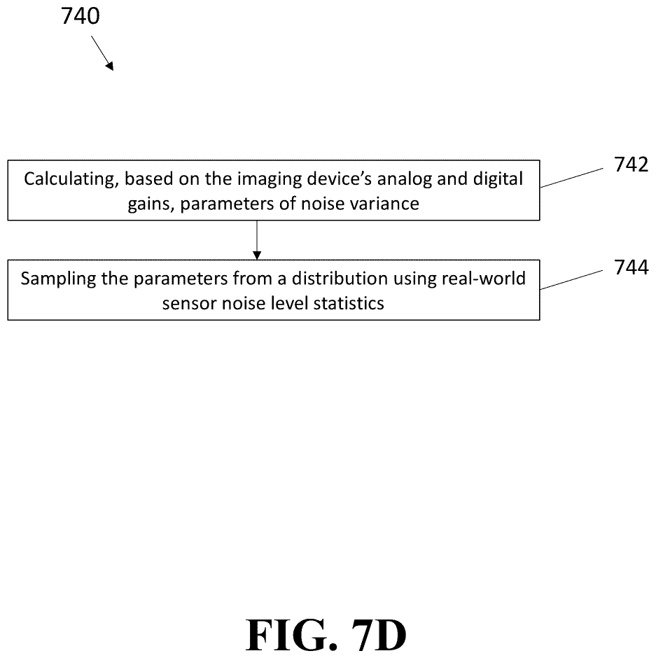

Turning now to FIG. 7A, a method 700 is shown of the steps used by at least one embodiment of the present invention to denoise and reconstruct an image. First, at block 710, a diffusion model is trained on a dataset that contains both images and captions for those images, to generate a trained diffusion model. Then, at block 730, the trained diffusion model is fine-tuned using real-world noise, to generate a fine-tuned diffusion model. At block 750, one or more raw images are input into the fine-tuned diffusion model. At block 770, one or more text captions describing the one or more raw images are also input into the fine-tuned diffusion model. Finally, at block 790, the fine-tuned diffusion model is run with the one or more raw images and one or more text captions, to generate one or more denoised and reconstructed images.

The training of the diffusion model (e.g., block 710) may comprise additional steps, as described above herein and as shown in FIG. 7B. At block 712, the dataset images are passed to a model to convert the dataset images to sensor raw images. At block 714, the captions for the dataset images are processed by an encoder, to generate embedding vectors. Then, at block 716, the sensor raw images, the embedding vectors, and simulated noise are all added to the diffusion model for training.

The fine-tuning of the trained diffusion model (e.g., block 730) may comprise additional steps, as described above herein and as shown in FIG. 7C. At block 732, samples can be captured using an imaging device (e.g., via a smartphone camera taking pictures of the samples on a computer screen). Then, at block 734, the captured samples are input into the trained diffusion model. At block 736, the embedding vectors are also input into the trained diffusion model. Then, at block 738, a low-rank set of parameters is optimized on the inputs to fine-tune the trained diffusion model. As described above herein, the captured samples may, in at least one example, comprise two sets of samples, specifically a noisier sample (one with a higher amount of noise) and a cleaner sample (one with a lower amount of noise). In at least one example, LORA is used for the fine-tuning.

FIG. 7D shows a method 740 of modeling noise to produce the simulated noise (e.g., simulated noise 214), as described above herein and according to at least one embodiment of the invention. At block 742, parameters of the noise variance (e.g., λ_{read} and λₛₕₒₜ) are calculated based on the imaging device's analog and digital gains. Then, at block 744, the parameters are sampled from a distribution using real-world sensor noise level statistics.

One or more of the examples described herein can be implemented on one or more computing systems, as described in further detail below.

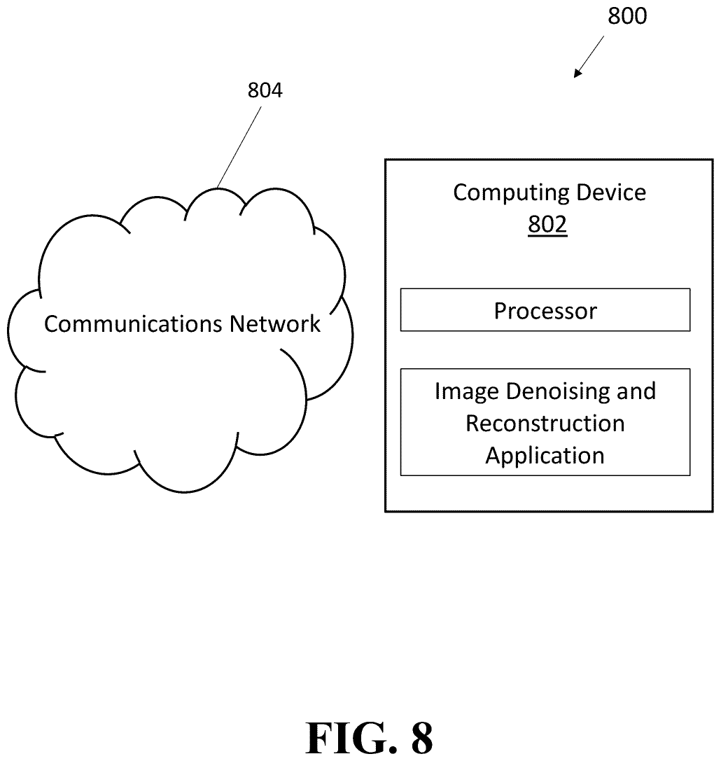

FIG. 8 is a block diagram of a computing system 800 for image denoising and image reconstruction, according to an example embodiment. Thus, the computing system 800 may comprise, for instance, any one or more of the modalities and/or components described herein, including, as a non-limiting example, the modalities and/or components described in FIG. 2. The system 800 comprises one or more computing devices 802 that may execute one or more applications to denoise and reconstruct an image. The applications can further be capable of scheduled or triggered communications or commands when various events occur (e.g., errors with the functioning of one or more of the modalities and/or components).

The one or more computing devices 802 can be used to store acquired images, graphs, textual data, and/or computational data, as well as other data in memory and/or a database. The memory may be communicatively coupled to one or more hardware processing devices.

The one or more computing devices 802 may further be connected to a communications network 804, which can be the Internet, an intranet, or another wired or wireless communications network. For example, the communications network 804 may include a Mobile Communications (GSM) network, a code division multiple access (CDMA) network, 3rd Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

The one or more computing devices 802 include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the image denoising and reconstruction application. In addition, the one or more computing devices 802 further include at least one communications interface to transmit and receive communications, messages, and/or signals.

Thus, information processed by the one or more computing devices 802, or the one or more applications executed thereon, may be sent to another computing device, such as a remote computing device, via the communication network 804.

Computing device 802 may be, for example, a user's smart phone, desktop computer, or other computing device, on which an image denoising and reconstruction application according to the present disclosure may be installed. This application may receive input (such as images to be denoised and denoising instructions) from the user and communicate with one or more remote computing devices via the communications network 804 to denoise and reconstruct the images via a diffusion model according to the present disclosure running on the one or more remote computing devices. In another example, computing device 802 may be a server or other computing device remote from users, which is accessed by user devices via a browser or other mechanism via, e.g., communications network 804. Users may, for example, upload images to the remote computing device 802 via e.g. their browsers in order to run a denoising and reconstruction diffusion model on them.

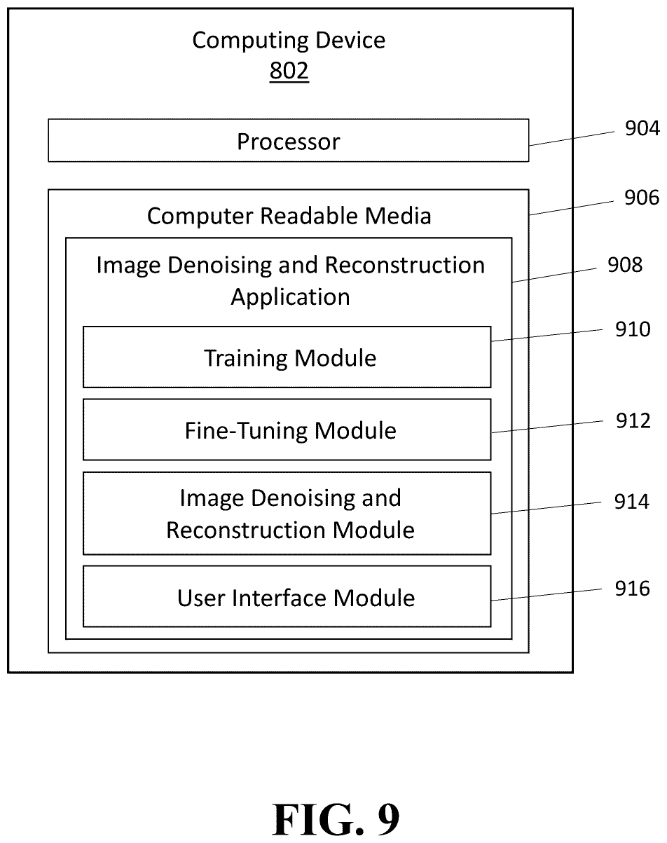

FIG. 9 is a block diagram of a computing device 802 according to an example embodiment. The computing device 802 includes computer readable media (CRM) 906 in memory on which an application for image denoising and reconstruction 908 or other user interface or application is stored. The computer readable media may include volatile media, nonvolatile media, removable media, non-removable media, and/or another available medium that can be accessed by the processor 904. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

As stated above herein, the image denoising and reconstruction application 908 may include one or more of the following different modules and/or components: (1) a training module 910, (2) a fine-tuning module 912, and (3) an image denoising and reconstruction module 914. The image denoising and reconstruction application 908 may also be operable to obtain data from one or more of the abovementioned modules and/or components, and to process, analyze, review, correct, and/or store that data that data.

Using a local high-speed network, the computing device 802 may receive the aforementioned data in near real time from one or more of the abovementioned modules and/or components, process the data, and generate one or more calculations, graphs, diagrams, and/or analyses. These calculations may be executed by one or more algorithms within the image denoising and reconstruction application 908 or other stored applications.

Measured or calculated data may be monitored to generate an event and an alert if an error occurs or if measured or calculated data is out of range. Such alerts may be sent in real-time or near real-time using an existing uplink or dedicated link. The alerts may be sent using email, SMS, push notification, or using an online messaging platform to end users and computing devices, among others.

The image denoising and reconstruction application 908 may provide data visualization using a user interface module 916 for displaying a user interface on a display device. As an example, the user interface module 916 generates a native and/or web-based graphical user interface (GUI) that accepts input and provides output viewed by users of the computing device 802. The computing device 802 may provide real-time automatically and dynamically refreshed information on image denoising steps, image reconstruction steps, and/or the functioning of one or more of the abovementioned modules and/or components. The user interface module 916 may send data to other modules of the image denoising and reconstruction application 908 of the computing device 802, and retrieve data from other modules of the image denoising and reconstruction application 908 asynchronously without interfering with the display and behavior of the user interface displayed by the computing device 802.

Thus, information processed by the computing device 802, or by the image denoising and reconstruction application 908 and/or one or more other applications, may be sent to another computing device, such as a remote computing device, via the communications network 804. As a non-limiting example, images for which denoising and reconstruction have been completed may be sent to one or more other computing devices, including, for instance, one or more user devices.

In some embodiments, one or more of modules 910, 912, 914, 916 shown on a single computing device 802 may be implemented across multiple computing devices. For example, they may be distributed between multiple computing devices, such as servers, remote from a user, or distributed between one or more computing devices remote from a user and one or more computing devices proximal to a user, such as a user's smart phone or desktop computer. For example, the user interface module 916 could run via an application installed on a user's smart phone, while the remaining modules are accessed on remote computing device(s) over a communications network.

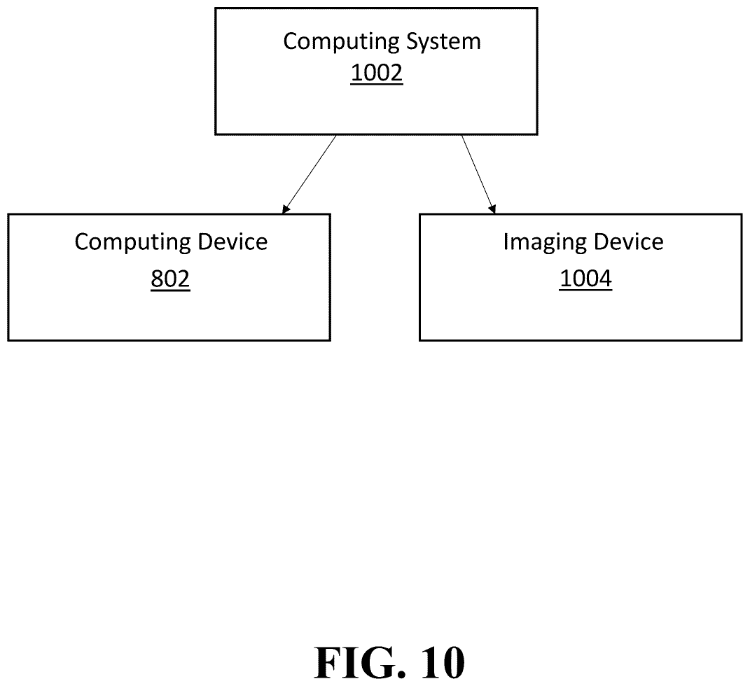

Further, one or more computing systems can implement one or more aspects of the technology and/or methods described herein. FIG. 10 shows an example of such a computing system 1002, which may include one or more computing devices (e.g., computing device 802) and/or processing units, which include one or more processors and software. The one or more computing devices (e.g., computing device 802) may execute one or more applications, such as, for example, the image denoising and reconstruction application 908 described above herein, or one or more portions thereof. The computing system 802 may further control, monitor, and/or extract data from, for instance, an imaging device 1004 (e.g., a smartphone camera). The computing system can further comprise a graphical user interface (GUI) so that a user may control the system or portions thereof, such as, for instance, the imaging device 1004.

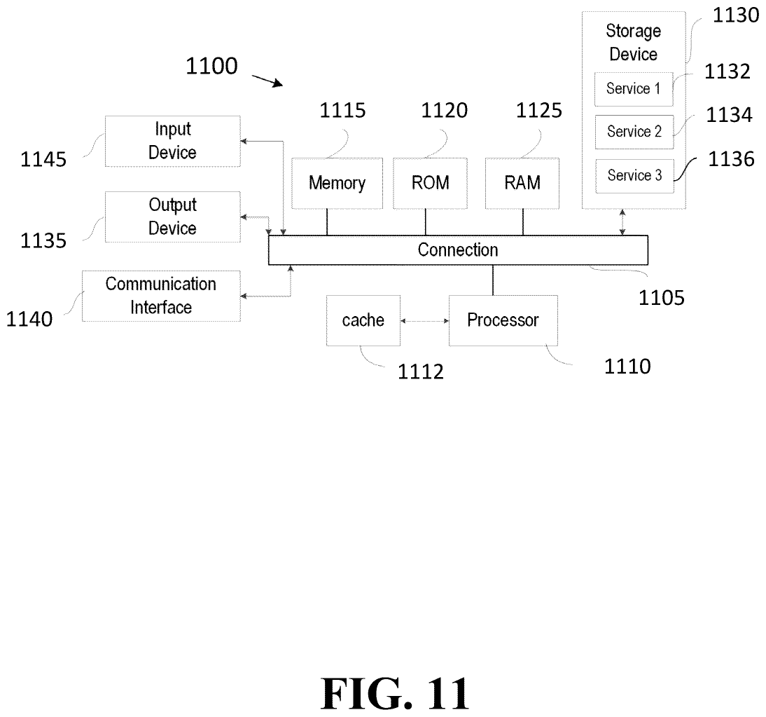

FIG. 11 shows an example of computing system 1100, which can be for example any computing device such as the computing device 802, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache of high-speed memory 1112 connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. There is no restriction on operating on any particular hardware arrangement, and therefore the basic features here may easily be substituted for improved hardware or firmware arrangements as they are developed.

Storage device 1130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

For clarity of explanation, in some instances, the present technology may be presented as including individual functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the disclosures herein can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

These and other objectives and features of the invention are apparent in the disclosure, which includes the above and ongoing written specification.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

What is claimed is:

1. A system comprising:
a memory storing computer-readable instructions; and
at least one processor to execute the computer-readable instructions to:
input one or more raw images into a text-conditioned neural network trained on a dataset comprising both (i) a plurality of dataset images, and (ii) a plurality of dataset captions for the plurality of dataset images;
input one or more text captions describing the one or more raw images into the text-conditioned neural network; and
run the text-conditioned neural network on the one or more raw images and the one or more text captions, to generate one or more denoised and reconstructed images.

2. The system of claim 1, the at least one processor further to execute computer-readable instructions to:
fine-tune the trained text-conditioned neural network using real-world noise.

3. The system of claim 2, wherein the fine-tuning the trained text-conditioned neural network using real-world noise further comprises:
capturing, by an imaging device, a plurality of samples; and
inputting the plurality of samples into the trained text-conditioned neural network.

4. The system of claim 3, wherein the fine-tuning the trained text-conditioned neural network further comprises processing, by an encoder, text descriptions of the plurality of captured samples to generate embedding vectors, and inputting the embedding vectors into the trained text-conditioned neural network.

5. The system of claim 4, wherein the fine-tuning the trained text-conditioned neural network further comprises optimizing a low-rank set of parameters on the plurality of samples and the embedding vectors to fine-tune the trained text-conditioned neural network.

6. The system of claim 3, wherein the plurality of samples comprises a first dataset and a second dataset, and wherein the first dataset has a higher amount of noise than the second dataset.

7. The system of claim 2, wherein the fine-tuning the trained text-conditioned neural network is performed using low-rank adaptation (LORA).

8. The system of claim 1, wherein the at least one processor executes the computer-readable instructions to further:
query, by a graphical user interface (GUI), a user to enter at least one text description of the one or more raw images, wherein the one or more text captions comprises the at least one text description.

9. The system of claim 1, the at least one processor further to execute computer-readable instructions to:
train the text-conditioned neural network on the dataset comprising both (i) the plurality of dataset images, and (ii) the plurality of dataset captions for the plurality of dataset images, to generate the trained text-conditioned neural network.

10. The system of claim 9, wherein the training the text-conditioned neural network further comprises:
passing, by the at least one processor, the plurality of dataset images to a model to convert the plurality of dataset images to a plurality of sensor raw images;
processing, by an encoder on the at least one processor, the plurality of dataset captions, to generate embedding vectors;
adding, by the at least one processor, simulated noise to the plurality of sensor raw images to create noisy images; and
training the text-conditioned neural network on the noisy images and the embedding vectors, using the sensor raw images as ground truth.

11. The system of claim 1, wherein the text-conditioned neural network is fine-tuned on a dataset that includes pairs of raw noisy images of actual objects with text captions, each pair comprising a high-noise image and a low-noise image.

12. The system of claim 1, wherein the text-conditioned neural network is a diffusion model.

13. A method comprising:
inputting, by at least one processor, one or more raw images into a text-conditioned neural network trained on a dataset comprising both (i) a plurality of dataset images, and (ii) a plurality of dataset captions for the plurality of dataset images;
inputting, by the at least one processor, one or more text captions describing the one or more raw images into the text-conditioned neural network; and
running, by the at least one processor, the text-conditioned neural network on the one or more raw images and the one or more text captions, to generate one or more denoised and reconstructed images.

14. The method of claim 13, further comprising fine-tuning, by the at least one processor, the trained text-conditioned neural network using real-world noise.

15. The method of claim 14, wherein the fine-tuning the trained text-conditioned neural network with real-world noise comprises:
capturing, by an imaging device, a plurality of pairs of sample images;
wherein in each pair of sample images both sample images are of the same scene and one image is captured with different imaging device settings than the other image in the pair, so that the one image is noisy and the other image is clean;
inputting, by the at least one processor, the noisy sample images into the trained text-conditioned neural network inputting, by the at least one processor, embedding vectors for the noisy sample images into the trained text-conditioned neural network; and
utilizing, by the at least one processor, a low-rank adaptation (LORA) on the plurality of noisy sample images and the embedding vectors to fine-tune the trained text-conditioned neural network, using the clean images as ground truth.

16. The method of claim 13, further comprising training, by the at least one processor, the text-conditioned neural network on the dataset comprising both (i) the plurality of dataset images, and (ii) the plurality of dataset captions for the plurality of dataset images, to generate the trained text-conditioned neural network.

17. The method of claim 16, wherein the training the text-conditioned neural network further comprises passing the plurality of dataset images to a model to convert the plurality of dataset images to a plurality of sensor raw images.

18. The method of claim 17, wherein the training the text-conditioned neural network further comprises processing, by an encoder, the plurality of dataset captions to generate embedding vectors.

19. The method of claim 18, wherein the training the text-conditioned neural network further comprises adding, by the at least one processor, simulated noise to the plurality of sensor raw images to create noisy images.

20. The method of claim 19, wherein the simulated noise is generated by:
calculating, based on an imaging device's analog and digital gains, parameters of noise variance; and
sampling the parameters from a distribution using real-world sensor noise statistics.

21. The method of claim 20, wherein the parameters comprise read and shot components.

22. The method of claim 19, wherein the training the text-conditioned neural network further comprises training the text-conditioned neural network on the noisy images and the embedding vectors, using the sensor raw images as ground truth.

23. The method of claim 16, wherein the training the text-conditioned neural network further comprises:
conditioning the text-conditioned neural network on a timestep value t by utilizing positional encoding followed by a first fully connected layer and a second fully connected layer, the first fully connected layer and the second fully connected layer separated by an activation function; and
conditioning the text-conditioned neural network to text input by utilizing a third fully connected layer and a fourth fully connected layer applied to text embedding vectors.

24. The method of claim 13, wherein the text-conditioned neural network is fine-tuned on a dataset that includes pairs of raw noisy images of actual objects with text captions, each pair comprising a high-noise image and a low-noise image.

25. A non-transitory computer-readable storage medium comprising instructions stored thereon that, when executed by a computing device cause the computing device to perform operations, the operations comprising:
inputting one or more raw images into a text-conditioned neural network trained on a dataset comprising both (i) a plurality of dataset images, and (ii) a plurality of dataset captions for the plurality of dataset images;
inputting one or more text captions describing the one or more raw images into the text-conditioned neural network; and
running the text-conditioned neural network on the one or more raw images and the one or more text captions, to generate one or more denoised and reconstructed images.

26. The non-transitory computer-readable storage medium of claim 25, wherein the operations further comprise:
capturing, by an imaging device, a plurality of samples;
inputting the plurality of samples into the trained text-conditioned neural network;
inputting embedding vectors associated with the plurality of samples into the trained text-conditioned neural network; and
utilizing a low-rank adaptation (LORA) on the plurality of samples and the embedding vectors to fine-tune the trained text-conditioned neural network.

27. The non-transitory computer-readable storage medium of claim 25, wherein the operations further comprise training the text-conditioned neural network on the dataset comprising both (i) the plurality of dataset images, and (ii) the plurality of dataset captions for the plurality of dataset images, to generate the trained text-conditioned neural network.

28. The non-transitory computer-readable storage medium of claim 27, wherein the training the text-conditioned neural network further comprises:
passing the plurality of dataset images to a model to convert the plurality of dataset images to a plurality of sensor raw images;
processing, by an encoder, the plurality of dataset captions, to generate embedding vectors;
adding simulated noise to the plurality of sensor raw images to create noisy images; and training the text-conditioned neural network on the noisy images and the embedding vectors, using the sensor raw images as ground truth.

29. The non-transitory computer-readable storage medium of claim 25, wherein the text-conditioned neural network is fine-tuned on a dataset that includes pairs of raw noisy images of actual objects with text captions, each pair comprising a high-noise image and a low-noise image.

30. The non-transitory computer-readable storage medium of claim 25, wherein the text-conditioned neural network comprises a diffusion model.
